(19) United States
(12) Patent Application Publication
(10) Pub. No.: US 2012/0047725 A1
(43) Pub. Date: Mar. 1, 2012

(54) Facility for forming lithium ion cells

(75) Inventors: Kurt Gschweitl, Eggersdorf (AT); Mario Schweiger, Graz (AT); Volker Diethelm Hennige, Graz (AT); Bernhard Kortschak, Deutschlandsberg (AT); Uwe Wiedemann, Graz (AT)

(73) Assignee: AVL LIST GMBH

(21) Appl. No.: 13/137,450

(22) Filed: Aug. 16, 2011

(30) Foreign Application Priority Data
Aug. 26, 2010 (AT) GM 528/2010
Oct. 4, 2010 (AT) GM 611/2010

(51) Int. Cl. H01M 10/14

(52) U.S. Cl. 29/730

(57) ABSTRACT

A facility for forming lithium ion cells 1 preferably comprises an object support for the lithium ion cells 1 to be formed, and a forming system which contains an electrical circuit having an AD/DC converter unit 3, with multiple DC outputs 4, as needed, to which the lithium ion cells may be connected in an electrically conductive manner.

To allow energy-optimized forming in this manner, a battery management system 6 is connected to each of the DC outputs 5, and is connectable to at least one lithium ion cell 1.

The invention relates to a facility for forming lithium ion cells, preferably comprising an object support for the lithium ion cells to be formed, and a forming system which contains an electrical circuit having an AD/DC converter unit, with multiple DC outputs, as needed, to which the lithium ion cells may be connected in an electrically conductive manner.

“Forming” refers to the first pass of a defined charging-discharging sequence of a lithium ion cell, and takes place in facilities specially designed for this purpose as part of the manufacturing process for lithium ion cells.

Lithium ion cells are understood to mean all types of electrochemical cells having an electrolyte that contains lithium. They may have a negative electrode, composed of a carrier film and an active material made of graphites, metals, alloys, or titanates, for encasing the lithium. In addition, a positive electrode may be provided which is composed of a carrier film and an active material containing lithium and at least one or more of the elements Ni, Mn, Co, Fe, Mg, V, P. The electrolyte may be present in liquid, solid, or gelled form, and a separator may also optionally be present.

The lithium ion cells to be formed are preferably fixed on an object support and supplied to the forming system. During the forming, each lithium ion cell is automatically connected in an electrically conductive manner to an electrical circuit. These circuits form the primary component of the forming system. The intermediate electrical circuit of the facility is implemented as an AC-DC inverter having one AC input and multiple DC outputs. System architectures of this type (one AC input, multiple DC outputs) typically provide two options for minimizing energy losses during the forming. The first option is an energy branch between separate DC circuits in order to divert the discharge energy of a lithium ion cell (at DC circuit 1) to another lithium ion cell (at DC circuit n) via the intermediate circuit, this energy being used to charge the lithium ion cell. The second option is energy recovery between the DC-AC circuit. The discharge energies (DC) of multiple lithium ion cells are bundled and fed back into the AC circuit via the intermediate circuit. In such facilities, the DC-AC energy recovery is characterized by low efficiency due to the low input voltages on the DC side. These DC outputs are characterized in that they achieve maximum DC output signals of <6 volts and currents of a few amperes to several hundred amperes.

The object of the present invention, therefore, is to design a forming facility in such a way that energy-optimized forming is possible.

To achieve this object, a facility as described at the outset is characterized in that a battery management system is connected to each of the DC outputs, and is connectable to at least one lithium ion cell. This allows more efficient and energy-optimized forming with regard to DC-AC energy recovery; however, the battery management system is preferably not a component of the forming system per se.

According to one advantageous embodiment of the facility, each of the DC outputs is implemented with capability for energy recovery.

According to another optional feature of the invention, it is advantageously provided that the forming system has one AC input and one DC output, the latter achieving maximum DC output signals up to several hundred amperes and hundreds of volts.

According to another embodiment of the invention, a DC/DC converter, preferably an isolated DC/DC converter, is connected to the, or each, DC output of the forming system, and is connected to the battery management system.

The cells may be supplied separately to the forming system. In one preferred design, the cells are individually fixed on an object support and supplied to the forming system via a feed system.

The invention is explained in greater detail in the following description, with reference to one exemplary embodiment and the accompanying drawings.

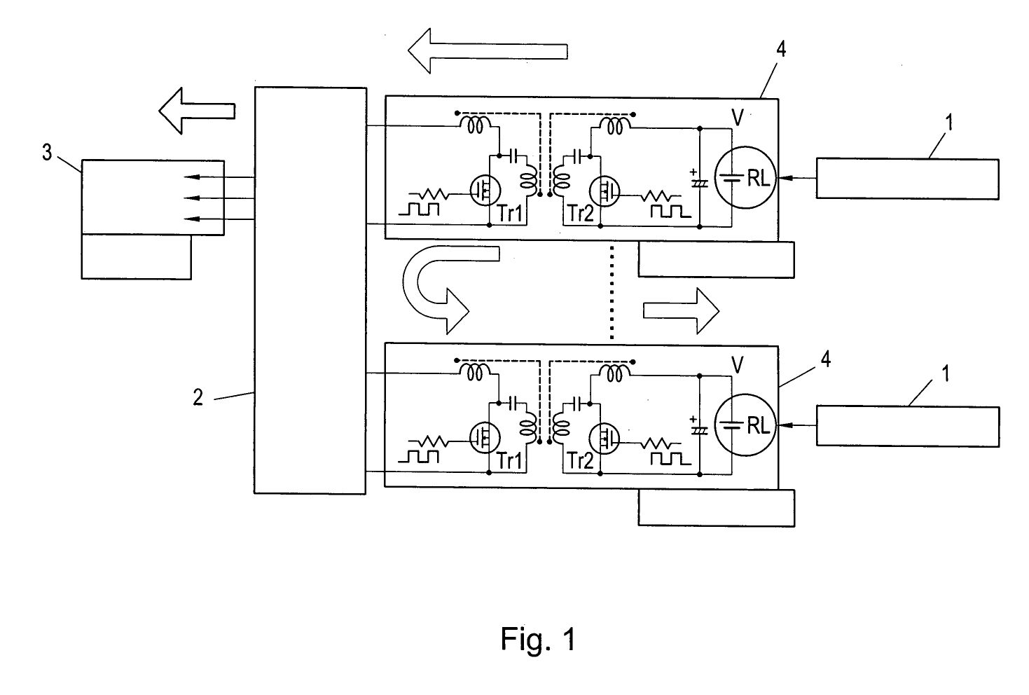

FIG. 1 shows the schematic layout of a forming system for lithium ion cells according to the prior art, having one AC input and n DC outputs, and

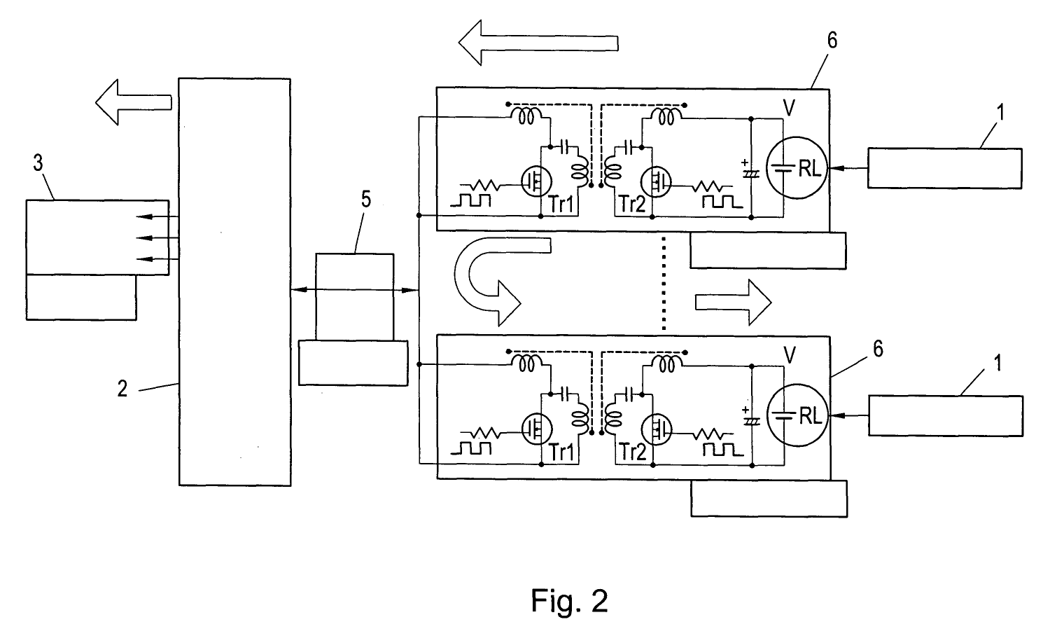

FIG. 2 is an illustration of the schematic layout of a forming system according to the invention which uses a battery management system.

The facility, whose circuit diagram is schematically illustrated in FIG. 1, is one possible exemplary embodiment of a facility for forming lithium ion cells 1, which are preferably fixed on an object support and supplied to the forming system. During the forming, each lithium ion cell 1 is automatically connected in an electrically conductive manner to an electrical circuit, the intermediate electrical circuit 2 of the facility being implemented as an AC-DC inverter having one AC input 3 and multiple—for instance two outputs as depicted in FIG. 1—DC outputs 4. Typically, a 2-way 3-phase inverter is used as the AC-DC inverter, and the AC input 3 is a 3-phase AC input. The DC outputs 4 are preferably isolation type DC/DC converters.

As symbolized by the arrow near the AC input 3, regenerative energy from the circuit 2 can be provided to the AC source. The arrow above the upper DC output 4 symbolizes the discharging current from the lithium ion cells 1, while the charging current is symbolized by the short arrow above the lower DC output 4. The bent arrow on the left side above the lower DC output 4 symbolizes a regeneration, an energy branch between separate DC circuits 4, whereby the discharge energy of one lithium ion cell 1 (e.g. the upper cell) to another lithium ion cell 1 (e.g. the lower cell) via the intermediate circuit 2, this energy being used to charge the lithium ion cell 1. To ensure more energy-efficient forming, a new facility design illustrated in FIG. 2 is provided in which, in principle, only one DC output 5 has to be provided. A battery management system 6 is connected to this DC output 5 or to each additional DC output, and is connectable to at least one lithium ion cell 1. An AC/DC inverter 2, typically a 2-way 3-phase inverter, and the AC input, typically a 3-phase AC input, are inserted between the AC source and the or every battery management system 6.

Battery management systems are used for controlling batteries, and usually include sensors for measuring cell temperatures, sensors for measuring individual cell voltages, sensors for measuring the current, an electronic circuit for shifting charges from one (arbitrary) cell into another cell (also referred to as balancing), and safety devices (protectors, fuses, etc.). As shown in FIG. 2 the battery management system 6 can be an isolating type DC/DC inverter or can comprise such inverter.

The battery management system 6 is used as an electrical interface between cells 1 to be formed and the forming system. The DC side of the energy to the individual lithium ion cells 1 is no longer distributed as part of the integrated circuits of the forming facility, and instead is distributed by the battery management system 6, which is also used as the interface for DC-AC energy recovery when the, or each, of the DC outputs 5 is advantageously a component of a forming system having capability for energy recovery. The forming system according to the invention has no more than one AC input 3, and advantageously has only one DC output 5, the latter achieving maximum DC output signals up to several hundred amperes and hundreds of volts. A DC/DC converter, preferably an isolated DC/DC converter 6, may be connected to the, or each, DC output 5 of the forming system, and connected to the battery management system.

Again the supply of regenerative energy, the discharging current from the lithium ion cells 1, the charging current for the lithium ion cells 1, as well as the regeneration and energy branch between separate battery management systems 6 is symbolized by the arrows similar to FIG. 1.

In one preferred design, before the forming the cells are electrically connected to one another to form a module. Up to five cells are usually connected to one another in parallel, and up to 14 cells are usually connected to one another in series, in a module. The battery management system, which may be part of the forming facility, is then directly connected to this module. In another embodiment, however, the battery management system is part of the module in the subsequent battery, and remains on the module after the forming. In another embodiment, multiple modules may also be connected to one another in series. In all cases, the charge may be balanced between any two cells. The computation of which cell receives charge and which cell delivers charge is carried out within the battery management system, and is independent of the forming facility.

1. A facility for forming lithium ion cells, comprising an object support for the lithium ion cells to be formed, and a forming system which contains an electrical circuit having an AD/DC converter unit, with multiple DC outputs to which the lithium ion cells may be connected in an electrically conductive manner, and a battery management system (6) connected to each of the DC outputs (5), and connectable to at least one lithium ion cell (1).

2. The facility according to claim 1, wherein each of the DC outputs (5) has capability for energy recovery.

3. The facility according to claim 1, wherein the forming system has one AC input (3) and one DC output (5), the DC output achieving maximum DC output signals up to several hundred amperes and hundreds of volts.

4. The facility according to claim 1, includinq a DC/DC converter connected to the, or each, DC output (5) of the forming system, and is connected to the battery management system.
